(19) United States
(12) Patent Application Publication
(10) Pub. No.: US 2006/0180039 A1
(43) Pub. Date: Aug. 17, 2006

(54) Wallpaper effect imprinting device and pattern sheet

(76) Inventor: Elizabeth Motta Leite, Rio de Janeiro (BR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/332,582

(22) Filed: Jan. 13, 2006

(30) Foreign Application Priority Data
Jan. 13, 2004 (BR) PI0500076-9

(51) Int. Cl. B41G 7/00

(52) U.S. Cl. 101/368

(57) ABSTRACT

A decorating imprinting device, pattern sheet and method are disclosed. The imprinting device is a multi-piece stamp made of polymer sponges, containing a relieved decorative design to be imprinted with paint material on a desired, relatively smooth surface, such as a wall, a piece of furniture. The pattern sheet is made of lightweight, flexible material, contains regularly made perforations of variable number, shapes and sizes to adapt to imprinting devices of different shapes and sizes. The pattern sheet is intended to be placed on the surface where the decorative design will be imprinted, allowing the operator to repetitively imprint the design on the selected surface through the perforations on the sheet, consistent and easily following the predetermined pattern, creating a wallpaper effect.

### BACKGROUND OF INVENTION

1) Field of the Invention

The present invention relates to an improved imprinting type of device that contains a relieved decorative design to be imprinted with paint or the like on a relatively smooth surface such as a wall or a piece of furniture. In order to create a wallpaper effect, the invention provides an improved multi-piece imprinting device and a pattern sheet that allows for repetitive imprinting following a predetermined pattern.

2) Description of Prior Art

The idea of making an imprinting device—also called a stamp—that is put in contact with ink or the like and pressed against a given surface to reproduce a design or character of any kind, dates as far back as the end of the nineteenth century, as is disclosed by Smith et al. (U.S. Pat. No. 518,515). An improved version of a rubber stamp was proposed by Selden et al. (U.S. Pat. No. 1,869,869) in the second quarter of the twentieth century. More recently, Bunger (U.S. Pat. No. 4,625,640) proposed a more complex version of an imprinting device, for imprinting successive images forming a composite imprint.

Different devices and methods have been used in interior design by professionals and amateurs alike, with a common intent: to create a unique or otherwise, but always nice, living or working environment, especially one pleasing to the eyes. Covering walls, furniture and other surfaces with different materials, such as paint, plain or patterned fabric, wood panels, and plain or patterned paper and plastic materials, including wallpaper, has been a common practice. The combined use of paint and an imprinting device has also been the object of development in this field.

A similar improved stamp type of device was probably first proposed as a method of decoration by Mitchell (GB 253,185) in 1925. Over the years, different products have been brought to market, and this technique has been widely used to obtain different decorative results, and consequently unmet needs have been detected. Several improvements in design, materials, and methods have been proposed: Matsumuro (U.S. Pat. No. D272,363, U.S. Pat. No. D272,364) has proposed a new design for a stamp with cap. Warn (GB598,731) proposed a device for decoration of surfaces, which design was similar to a stamp but the method of creating images on a surface was by removing wet paint material with the device, instead of applying paint with it. Another stamp type of device to remove wet paint from the surface and create a so-called textured effect was proposed by Bourboulis (U.S. Pat. No. 3,669,069). More recently, Carsel (U.S. Pat. No. 5,832,832, U.S. Pat. No. 5,857,411) has proposed an improved imprinting device that gains so-called ergonomic characteristics. Another approach has been proposed by Wasylczuck (U.S. Pat. No. 5,655,451) with a more complex imprinting device, where interfitting stamps can create a pattern with different ornamental designs on walls or other surfaces. McGuire (U.S. Pat. No. 4,030,414) has proposed a large, one-piece imprinting device, with more than one imprinting face, where one of the faces has the entire relieved ornamental design to be imprinted on a wall, and another face has a part of the design.

Hagen (U.S. Pat. No. 3,817,178) has proposed a complex approach to repetitive stamping on walls, where not only measurements and a chalk line are necessary, but also the device utilizes a chain connected at one end to the device and at the other end to the wall.

Although not closely related to the present invention, also of note is the original approach taken by Barbanell (U.S. Pat. No. 5,056,880), with what he calls holographic wallpaper that can create a 3-D effect on a wall in the presence of a laser illuminating system. All in all, the different ideas proposed over time and across the world illustrate the effort made to meet peoples' need or desire to decorate surfaces with images.

### BRIEF SUMMARY OF THE INVENTION

Nice results can be obtained with wallpapering, but one may try to avoid wallpapering because of the somewhat messy nature of the technique, its unforgiving nature with regard to minor mistakes of the operator, and above all because of the labor-intensive and even messier nature of the process of removing the wallpaper and going back to the previous finishing or trying a new one, whether paint or other, in case of a change of heart.

None of the imprinting devices and methods described above take into account one or both of following needs: (1) a means to repetitively imprint the decorative designs in a regular, well-measured fashion, such as a wallpaper pattern, especially when dealing with larger surfaces, such as a wall. In order to do that with any of the aforementioned devices, one would have to deal with different measuring tools, and yet, results would heavily depend on the operator's skill to use those measuring tools, would be hard to obtain, and would be extremely time-consuming. And (2) when attempting to repetitively imprint on a surface, especially the walls of a room, trying to create a wallpaper effect, there is a need to take into account some obstacles the operator may face when using an imprinting device. Individual imprinting devices containing parts of the decorative design should be provided, for use in wall corners and close to doors, for example, when such a need cannot be avoided.

The present invention takes into account both needs and proposes an improved, multi-piece imprinting device and a pattern sheet that allows for easy repetitive imprinting on a selected surface, because the pattern is predetermined, it is already measured and no further measurements are needed. A method for their combined use is also disclosed.

### OBJECTS OF THE PRESENT INVENTION

The primary object of this invention is to provide one with means to easily, efficaciously, and cost-effectively create a wallpaper type of effect on a surface from an imprinting device.

A further object of the present invention is to provide a simple pattern for easy and precise repetitive imprinting.

Another object of this invention is to provide an improved imprinting device that (1) facilitates imprinting in the presence of an obstacle, such as internal corners of the walls in a room and close to doors, and (2) is designed in a way that helps one follow a pattern during the repetitive imprinting process.

### BRIEF DESCRIPTION OF THE SEVERAL VIEWS OF THE DRAWINGS

FIG. 1 is a top plan view of a round base imprinting device that shows a piece containing the entire decorative design.

FIG. 2 is a top plan view of two other pieces of the imprinting device, where FIG. 2a shows a piece containing a vertically cut half of the decorative design, and FIG. 2b shows a piece containing the other vertically cut half of the decorative design.

FIG. 3 is a top plan view of two other pieces of the imprinting device, where FIG. 3a shows a piece containing a horizontally cut half of the decorative design, and FIG. 3b shows a piece containing the other horizontally cut half of the decorative design.

FIG. 4 is a bottom plan view of a round base imprinting device.

FIG. 5 is bottom plan view of two other pieces of the imprinting device, where FIG. 5a represents one vertically cut half, and FIG. 5b represents the other vertically cut half.

FIG. 6 is a bottom plan view of two other pieces of the imprinting device, where FIG. 6a represents one horizontally cut half, and FIG. 6b represents the other horizontally cut half.

FIG. 7 is a vertical cross-section of a round base imprinting device.

FIG. 8 is a top plan view of a pattern sheet containing round perforations.

FIG. 9 is a perspective view showing a pattern sheet placed on wall A to be decorated, held in place by pieces of masking tape.

FIG. 10 is an exploded view of FIG. 9, where the imprinting device is positioned to imprint the decorative design through one of the perforations of the pattern sheet.

FIG. 11 is the same view as in FIG. 10, where the imprinting device is positioned to imprint the decorative design through another perforation of the pattern sheet.

FIG. 12 is a perspective view showing the pattern sheet placed on the corner of wall A and wall C, where the piece of the imprinting device shown in FIG. 2a and 5a is positioned to imprint half of the decorative design on wall A, through a perforation of the pattern sheet.

FIG. 13 is a perspective view showing the pattern sheet placed on the corner of wall A and wall C, where the piece of the imprinting device shown in FIG. 2b and 5b is positioned to imprint the other half of the decorative design on wall C, through a perforation of the pattern sheet.

FIG. 14 is a top plan view of a complementary pattern sheet containing triangular perforations.

FIG. 15 is a perspective view showing a complementary imprinting device being used with a complementary pattern sheet.

### DETAILED DESCRIPTION OF THE INVENTION

The present invention proposes an improved, multi-piece imprinting device, a pattern sheet to allow for repetitive imprinting on a selected surface, and a method for their combined use.

Imprinting Device and Pattern Sheet:

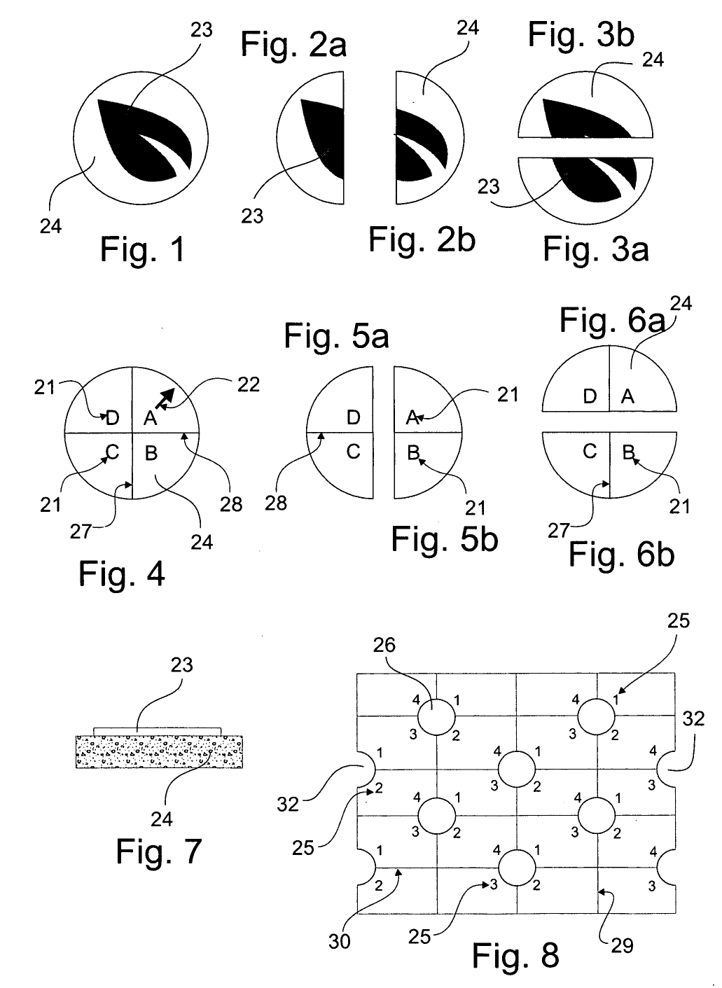

The imprinting device is a multi-piece stamp made of polymer sponges, containing a relieved decorative design to be imprinted with paint or the like on a desired, relatively smooth surface, such as a wall of a piece of furniture. One of the pieces of the imprinting device contains the entire design (FIG. 1 and FIG. 4), the other pieces contain halves of the design, such as vertically cut halves of the design (FIG. 2, FIG. 2a, FIG. 2b, FIG. 5, FIG. 5a, and FIG. 5b) and horizontally cut halves of the design (FIG. 3, FIG. 3a, FIG. 3b, FIG. 6, FIG. 6a, and FIG. 6b), to allow for imprinting just a part of the decorative design, in case of need, for example in the presence of an obstacle such as a wall corner or a door. Also, the design to be imprinted is oftentimes asymmetrical, and the operator may decide to imprint the decorative design in different positions, during the repetitive imprinting process, such as first upside up and then upside down, to obtain a nicer effect. The pieces containing vertically and horizontally cut halves of the design allow the operator to use the device to imprint the design in different positions, even before an obstacle.

The upper part 23 of the body (FIG. 7) of the imprinting device proposed is made of a soft and resilient polymer sponge that contains the design to be imprinted with paint on a relatively smooth surface. The base 24 of the body (FIG. 7) of the imprinting device is made of a harder polymer sponge, is thicker than the upper part, and is used as a holder. The imprinting device can contain a variety of designs and can have different sizes. The base of the imprinting device can have a variety of shapes, but the shape of the base needs to match that of the perforations in the pattern sheet. For example, a round base imprinting device is intended to be used with pattern sheets with round perforations. Also, as imprinting devices are provided in different sizes, one can have a large round base imprinting device and a smaller round base imprinting device. Therefore, pattern sheets with round perforations of different sizes are provided. The same is true for bases of imprinting devices and perforations in pattern sheets with other shapes.

The vertical line 27 and the horizontal line 28 on the base of the imprinting device serve as a guide for the operator during the imprinting process. Those lines should be aligned to the vertical and horizontal lines on the pattern sheet. The orientation sign, such as an arrow 22 on the base of the imprinting device that contains the entire decorative design is intended to help the operator position the imprinting device on the selected surface, during the imprinting process. The letters A, B, C, and D 21 are used to identify the quarters of the imprinting design (FIG. 1, FIG. 2, FIG. 3, and FIG. 12).

The pattern sheet (FIG. 8) contains regularly made perforations 26 and perforation halves 32, and is intended to be placed on the surface where the decorative design will be imprinted, allowing the operator to repetitively imprint the design on the selected surface through the perforations in the sheet, consistent and easily following the pattern, creating a wallpaper effect. The pattern sheet is provided in a variety of sizes and with a different number of perforations, to create different patterns. The perforations may vary in shape and size to adapt to the base shapes and sizes of the imprinting devices.

The vertical lines 29 and the horizontal lines 30 on the pattern sheet divide the perforations in quarters 25, which are numbered in a clock-wise fashion: the upper right quarter is #1, the lower right quarter is #2, the lower left quarter is #3, and the upper left quarter is #4. The quarters are intended to help the operator select a desired position to place the imprinting device and design to be imprinted. The numbering system also helps the operator to consistently select the sequence of positions of the imprinting device, to follow a pattern during the repetitive imprinting process. When placing the imprinting device on the selected surface, through a perforation in the pattern sheet, the lines on the imprinting device should be aligned to those on the sheet.

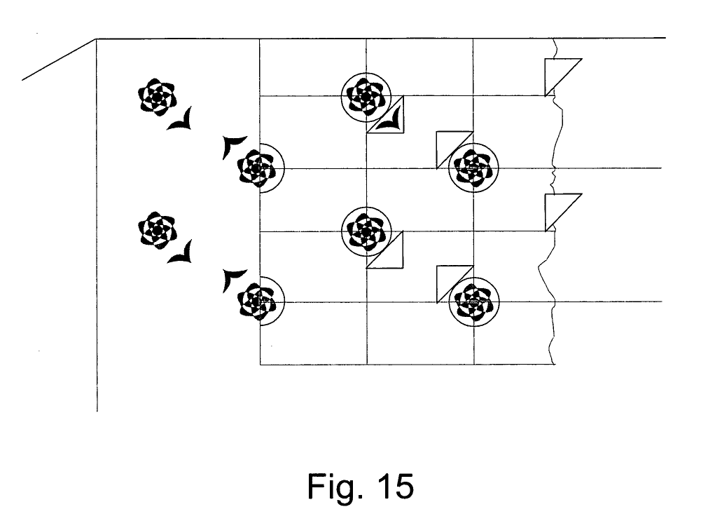

Complementary pattern sheets (FIG. 14) are provided for use with complementary imprinting devices (FIG. 15). Pattern sheets are intended to be used first, before the complementary pattern sheets, or alone. Pattern sheets and complementary pattern sheets contain regularly made perforations that serve as a guide for the operator to imprint the decorative design on the selected surface. The complementary pattern sheet is only necessary when using a complementary imprinting device that contains another decorative design that is complementary to the previous one used. The complementary imprinting device and the pattern sheet are intended to allow the operator to use a different color paint to imprint that complementary decorative design, thus avoiding the risk of paint blurs when trying to imprint a decorative design in different colors, using the same imprinting device. Pattern sheets are made of flexible, lightweight material. Complementary pattern sheets are made of flexible, lightweight, translucent material to allow for its better placement on the surface where the first design has already been imprinted.

Combined Use of Imprinting Devices and Pattern Sheets:

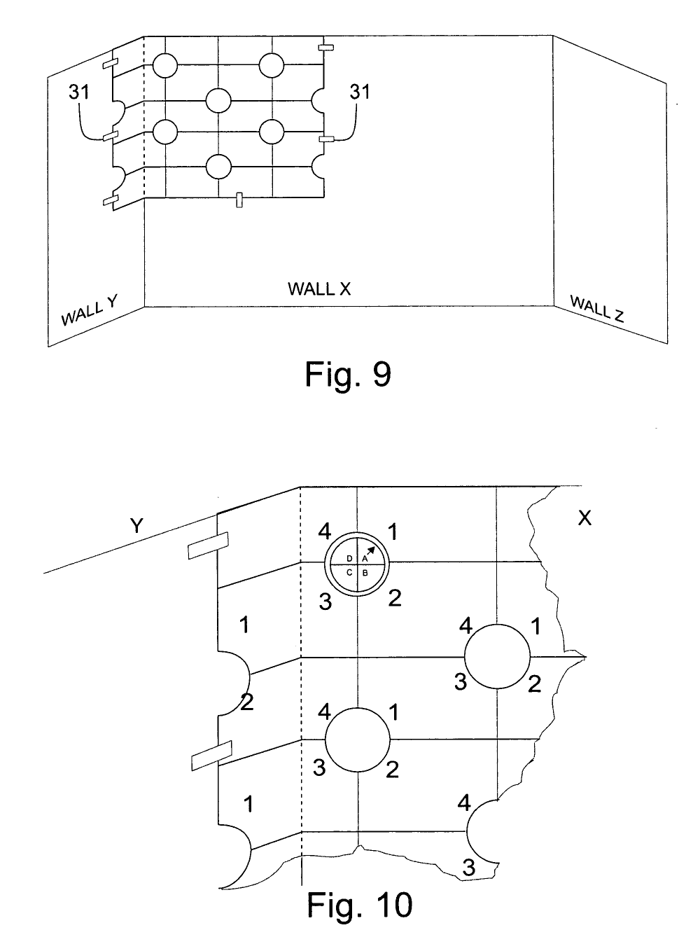

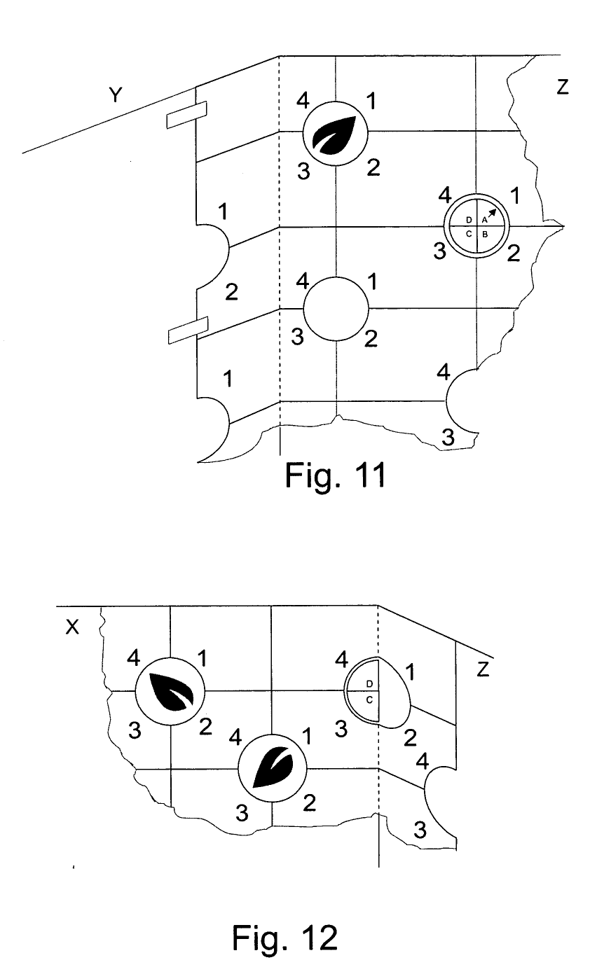

In order to achieve the said wallpaper effect, the operator should first place the pattern sheet on the selected surface (FIG. 9), aligned to the ceiling line, for example, and hold it in place with the help of pieces of 1″ masking tape 31. Then, the operator should proceed with the imprinting process, preferably starting with the imprinting device with the entire decorative design on it. The selected paint material, preferably water soluble paint, should be applied to the surface of the decorative design, preferably with the help of a foam brush. The imprinting device should be placed on the desired position—the arrow 22 on its base pointing to quarter 1, 2, 3 or 4 25 (FIG. 10). The vertical 27 and horizontal 28 lines on the base of the imprinting device should be aligned with the vertical 29 and horizontal 30 lines on the pattern sheet, in order to keep the device in the correct position. The operator repetitively imprints through the other perforations (FIG. 11) of the pattern sheet. The decorative design can be re-imprinted in the same position, arrow 22 always pointing to position 1, or always point to position 2, etc. A change in position can be achieved by positioning the arrow on the base of the imprinting device pointing each time to a different quarter, following the numbering system.

When the design is imprinted through all the perforations, the pattern sheet should be removed and repositioned on the same surface, moving it to the right, for example, where imprinting stopped. The pattern sheet should then be held in place by the pieces of masking tape that should be pressed against the surface, and the imprinting process should restart.

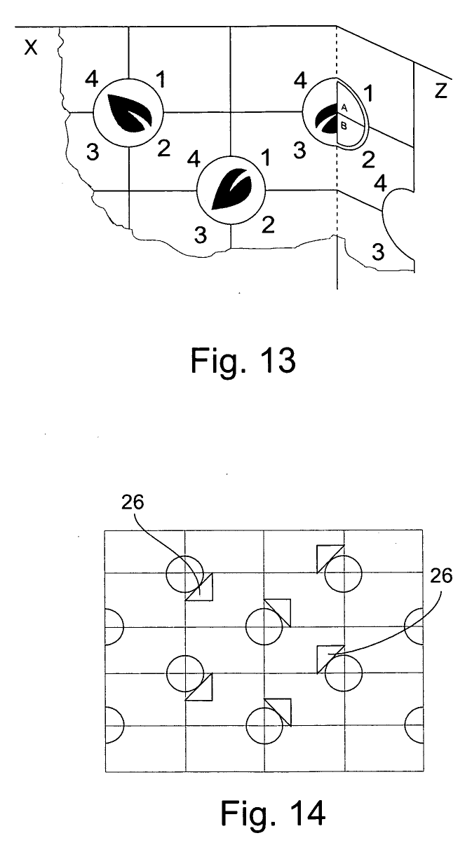

In case of need of a half design, the piece of the imprinting device containing the necessary half of the decorative design should be selected and the design imprinted (FIG. 12). If the other half of the design is needed, in case of imprinting in internal wall corners (FIG. 13), for example, the operator should wait for the paint to dry, select the other half that complements the first one used, as shown in FIG. 5 and FIG. 6, and proceed with the imprinting process.

In case of using an imprinting device and its complementary imprinting device, the operator should first imprint the decorative design with the help of its pattern sheet and wait till the paint dries to apply the complementary decorative design with the help of its complementary pattern sheet (FIG. 15).

What is claimed is:

1. An imprinting device made of a flexible, resilient material, comprising:
an upper part containing at least one decorative design, and
a base having an inferior face,
wherein the inferior face of the base has orthogonal guiding lines that divide and identify the base into quarters.

2. An imprinting device, as described in claim 1, wherein one of the quarters on the inferior face of the base has an orientation sign.

3. An imprinting device containing a fraction of the decorative design of a full imprinting device as described in claim 1, wherein the imprinting device containing the fraction of the decorative design corresponds to a fraction of the shape of the full imprinting device, which is limited by one of the vertical and horizontal guide lines.

4. A pattern sheet comprising:
regularly made perforations on a central portion of the sheet,
regularly made perforation halves on a border of the sheet, and
orthogonal guiding lines dividing the perforations into quarters.

5. A pattern sheet, as described in claim 4, wherein the pattern sheet is made of flexible, lightweight material.

6. A complementary pattern sheet for a first patttern sheet that has regularly made perforations on a central portion of the first pattern sheet, regularly made perforation halves on a border of the first pattern sheet, and orthogonal guiding lines dividing the perforations into quarters, the complementary pattern sheet comprising:
regularly made drawings that simulate the perforations on the first pattern sheet, on a central portion of the complementary pattern sheet,
regularly made drawings that simulate the perforation halves on the first pattern sheet, on a border of the complementary pattern sheet,
orthogonal guiding lines dividing the simulated perforations into quarters, and
regularly made perforations, bordering the simulated perforations.

7. A complementary pattern sheet, as described in claim 6, wherein the complementary pattern sheet is made of flexible, lightweight material.

8. A method for the combined use of an imprinting device and a first pattern sheet, the imprinting device having an upper part containing at least one decorative design, and a base having an inferior face, wherein the inferior face of the base has orthogonal guiding lines that divide and identify the base into quarters, and wherein one of the quarters on the inferior face of the base has an orientation sign, the first pattern sheet having regularly made perforations on a central portion of the first pattern sheet, regularly made perforation halves on a border of the first pattern sheet, and orthogonal guiding lines dividing the perforations into quarters, the method comprising the steps of:
a) attaching the first pattern sheet on a selected surface to be imprinted, horizontally and vertically aligned to pre-existing surface lines;
b) applying paint or the like to the surface of the decorative design on the upper part of the imprinting device;
c) placing the imprinting device with the entire decorative design on the selected surface, through a perforation of the first pattern sheet, with the orientation sign pointing to a selected quarter of the first pattern sheet;
d) aligning the orthogonal lines of the imprinting device with those of the first pattern sheet;
e) pressing the imprinting device against the surface;
f) repeating the imprinting process from steps b) to e) utilizing the other perforations, changing the direction of the orientation sign to another quarter of the first pattern sheet, if desired; and
g) removing the first pattern sheet and repositioning the first pattern sheet on the same surface, shifted upwards, downwards, to the right or to the left, and repeating steps a) to f).

9. A method for the combined use of the imprinting device and first pattern sheet, as described in claim 8, further comprising the steps of:
h) using a fractional imprinting device with a fraction of the decorative design, placing the fractional imprinting device in the desired position through the perforation half of the first pattern sheet, applying paint to the design surface of the fractional imprinting device, aligning the orthogonal lines of the fractional imprinting device to those of the first pattern sheet, and pressing the fractional imprinting device against the surface to be imprinted.

10. A method for the combined use of the imprinting device and pattern sheet, as described in claim 8, with a complementary pattern sheet having regularly made drawings that simulate the perforations on the first pattern sheet, on a central portion of the complementary pattern sheet, regularly made drawings that simulate the perforation halves on the first pattern sheet, on a border of the complementary pattern sheet, orthogonal guiding lines dividing the simulated perforations into quarters, and regularly made perforations, bordering the simulated perforations, the method further comprising the steps of:
i) removing the first pattern sheet and attaching the complementary pattern sheet on the surface to be imprinted positioning the simulated perforations on the already imprinted designs, making sure the complementary pattern sheet is horizontally and vertically aligned to the surface pre-existing lines;
j) applying paint or the like to the surface of the decorative design on the upper part of the complementary imprinting device;
k) placing the complementary imprinting device on the selected surface, through a perforation of the complementary pattern sheet;
l) pressing the complementary imprinting device against the surface;
m) repeating the imprinting process from steps i) to l) utilizing the other perforations; and
n) removing the complementary pattern sheet and repositioning the complementary pattern sheet on the same surface, shifted upwards, downwards, to the right or to the left, and repeating steps j) to f).
